(19) United States
(12) Patent Application Publication
(10) Pub. No.: US 2012/0328909 A1
(43) Pub. Date: Dec. 27, 2012

(54) MONITORING ELECTRODE AND SECONDARY BATTERY USING THE SAME

(75) Inventor: Dong Gun Kim, Gunpo (KR)

(73) Assignees: KIA MOTORS CORPORATION, Seoul (KR); HYUNDAI MOTOR COMPANY, Seoul (KR)

(21) Appl. No.: 13/313,885

(22) Filed: Dec. 7, 2011

(30) Foreign Application Priority Data
Jun. 22, 2011 (KR) 10-2011-0060524

(51) Int. Cl. H01M 10/48; H01M 10/42

(52) U.S. Cl. 429/50; 429/91

(57) ABSTRACT

This invention relates to a monitoring electrode for measuring voltage of each of a cathode and an anode of a secondary battery including the cathode, the anode and an electrolyte, which includes a first end portion inserted into the secondary battery so as to be incorporated in the electrolyte but disposed so that it is not in contact with the cathode or the anode; and a second end portion extending from the first end portion and having branches respectively connected to the cathode and the anode, and to a secondary battery using the same.

### CROSS-REFERENCE TO RELATED APPLICATIONS

This application claims under 35 U.S.C. §119(a) priority to Korean Application No. 10-2011-0060524, filed on Jun. 22, 2011, the disclosure of which is incorporated herein by reference in its entirety.

### BACKGROUND OF THE INVENTION

1. Field of the Invention

The present invention relates to a monitoring electrode configured to measure a difference in potential between a cathode and an anode of a secondary battery and also a voltage of each of the cathode and the anode, and to a secondary battery using the same.

2. Description of the Related Art

In the case of electric automobiles, hybrid automobiles, etc., safety of a battery is directly related to the marketability of vehicles. Currently, the energy capacity of a battery for an electric automobile is required to be about 16˜27 kWh. In the battery system of electric automobiles, the cells of the battery are responsible for storing and emitting energy. If the number of cells is lower based on the same energy capacity, the number of instruments and electric/electronic sub assemblies may also be decreased, making it possible to reduce the weight of the battery system and the volume thereof. Thus, there is the demand for high energy battery cells, as used in hybrid vehicle, in electric automobiles as well.

The energy is obtained by multiplying the capacity by voltage, and high energy of cells means an increase in the capacity and density of the cell. However, because the safety of the battery is inversely proportional to the capacity and energy density, safety becomes reduced at higher energy outputs.

Hence, with the goal of continuously monitoring the performance and safety of the battery to prevent incidents from occurring, voltage of each of a cathode and an anode of a cell should be monitored. In the case where a monitoring electrode for monitoring the voltage of each of a cathode and an anode and a secondary battery using the same are provided, performance of the battery may be prevented from deteriorating thus increasing service life. Also, the battery may be controlled and managed before safety-related problems occur, and thus safety and marketability of a high-voltage battery may be increased.

Furthermore, the battery is a component that continuously deteriorates unlike other automobile components. Hence, it is important to diagnose the SOH (State of Health) in order to give accurate information (e.g., remaining traveling distance and so on) to customers. In conventional cases, however, SOH cannot but be presumed by calculating resistance from changes in voltage between both ends of the battery.

Meanwhile, in electric automobiles, there is an urgent need to reduce the charging time. Typically, the battery of an electric automobile does not deteriorate without precipitating lithium so long as the voltage of an anode to 0 V or less upon low-temperature charging or rapid charging. Even from this point of view, techniques for measuring the voltage of each of both ends of the battery are required.

In particular, a conventional lithium secondary battery has a battery voltage of 4.2 V, a cathode voltage of 4.3 V, and an anode voltage of 0.1 V, upon completion of normal charging. However, upon abnormal charging such as low-temperature charging or rapid charging, the battery voltage is 4.2 V but the cathode voltage may be increased to the level of more than or equal to 4.3 V or the anode voltage may be decreased to the level of less than or equal to 0.1 V, due to an increase in the overvoltage of a cathode and an anode. In this case, when the cathode voltage is increased to the level of more than or equal to 4.3 V, the electrolyte may decompose, thus undesirably deteriorating the performance of the battery and generating gas in the battery as a result of side reactions. Also in the case where the anode voltage is decreased to the level of less than or equal to 0 V, the lithium ions are not inserted into the anode but instead are precipitate as lithium metal, undesirably deteriorating the performance of the battery and possibly causing an internal short-circuit, resulting in lowered safety (i.e., lithium is stable in an ionic state but is unstable in a metal state). In order to solve such problems, there is a need for techniques for independently measuring the voltage of a cathode and an anode in a battery in an electric or hybrid vehicle.

This related art is merely utilized to enhance understanding about the background of the present invention, and will not be regarded as conventional techniques known to those having ordinary knowledge in the art.

### SUMMARY OF THE INVENTION

Accordingly, the present invention has been made keeping in mind the above problems encountered in the related art, and an object of the present invention is to provide a monitoring electrode which may measure a difference in potential between a cathode and an anode of a secondary battery and as well measure the voltage of each of the cathode and the anode, and also to provide a secondary battery using the same.

In order to accomplish the above objects, an aspect of the present invention provides a monitoring electrode for measuring voltage of each of a cathode and an anode of a secondary battery comprising the cathode, the anode and an electrolyte, the monitoring electrode having a first end portion inserted into the secondary battery so as to be incorporated in the electrolyte but positioned so that it is not in contact with the cathode or the anode, and a second end portion extending from the first end portion and having branches respectively connected to the cathode and the anode.

In this aspect, the first end portion may be coated with an insulating layer so that it is insulated from the cathode and the anode in the electrolyte. Accordingly, the first end portion may be coated with any one selected from among platinum, lithium, and lithium titanate.

Another aspect of the present invention provides a monitoring electrode for measuring voltage of each of a cathode and an anode of a secondary battery including the cathode, the anode and an electrolyte. More specifically, the monitoring electrode includes a pair of first end portions inserted into the secondary battery so as to be incorporated in the electrolyte but positioned so as to not be in contact with the cathode or the anode, and a pair of the second end portions extending from the pair of first end portions and connected to the cathode and the anode, respectively.

A further aspect of the present invention provides a secondary battery, having a housing with an inner space defined thereby; a cathode and an anode received in the inner space of the housing; an electrolyte loaded in the inner space of the housing; and a monitoring electrode having a first end portion inserted into the inner space of the housing so as to be incorporated in the electrolyte but positioned so that is not in contact with the cathode or the anode, and a second end portion extending from the first end portion and having branches respectively connected to the cathode and the anode.

In this aspect, the secondary battery may further include a switching part connected to the first end portion and the branches of the second end portion of the monitoring electrode so that the first end portion and the cathode, the first end portion and the anode, or the cathode and the anode are electrically connected. Additionally, the secondary battery may further include a voltage measurement part connected to the switching part to measure a difference in potential between the first end portion and the cathode or the first end portion and the anode.

### BRIEF DESCRIPTION OF THE DRAWINGS

FIG. 1 is a perspective view showing a secondary battery according to an exemplary embodiment of the present invention;

FIG. 2 is a block diagram showing the secondary battery of FIG. 1; and

FIG. 3 is a block diagram showing a secondary battery according to another exemplary embodiment of the present invention.

### DESCRIPTION OF SPECIFIC EMBODIMENTS

Hereinafter, a monitoring electrode and a secondary battery using the same according to preferred embodiments of the present invention will be described with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

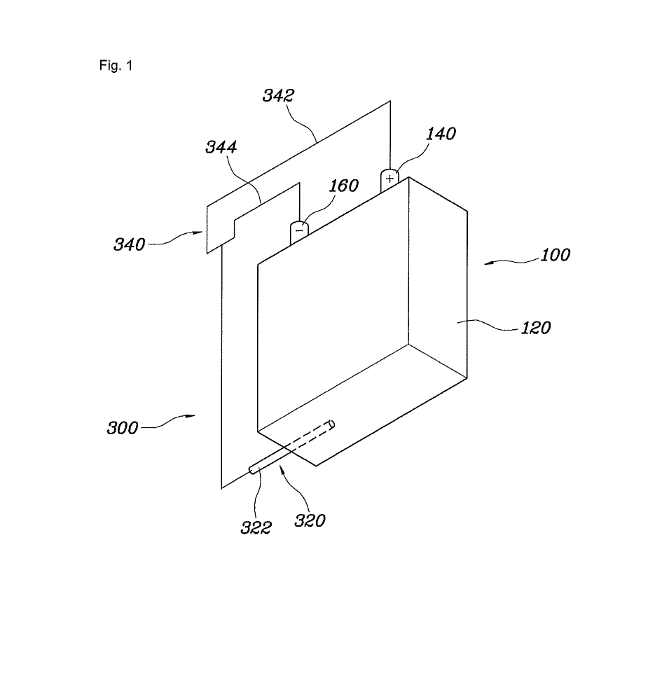

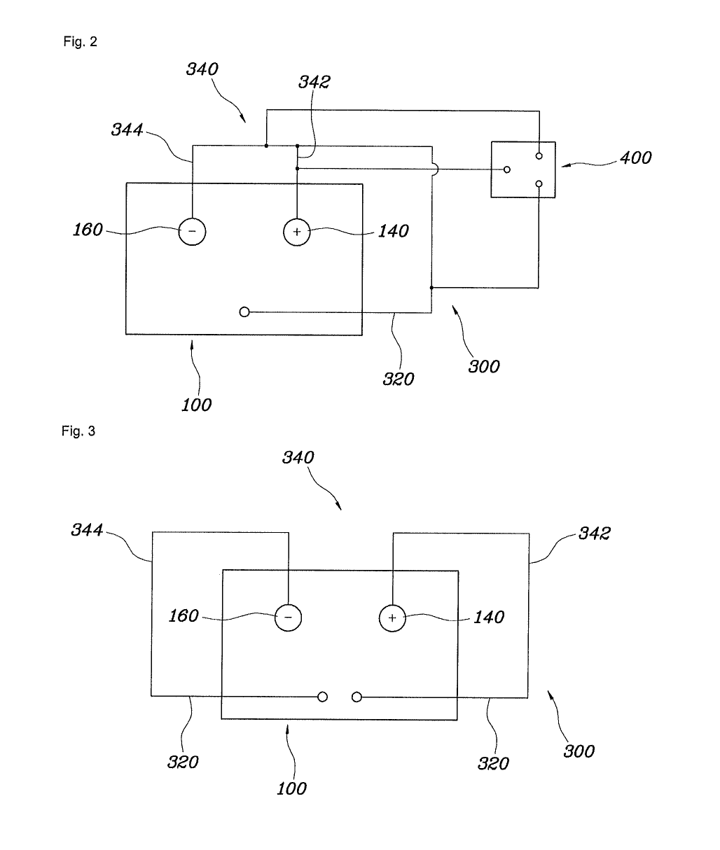

FIG. 1 is a perspective view showing a secondary battery according to an embodiment of the present invention, and FIG. 2 is a block diagram showing the secondary battery of FIG. 1.

Used for the secondary battery according to the embodiment of the present invention, a monitoring electrode functions to measure voltage of each of a cathode 140 and an anode 160 of a secondary battery 100 comprising the cathode 140, the anode 160 and an electrolyte 120, and includes a first end portion 320 inserted into the secondary battery 100 so as to be incorporated in and surrounded by the electrolyte 120 but positioned so it is not in contact with the cathode 140 or the anode 160, and a second end portion 340 extending from the first end portion 320 and having branches 342, 344 respectively connected to the cathode 140 and the anode 160.

The secondary battery 100 is typically configured such that a housing is provided, and the cathode 140, the anode 160 and the separator for separating them are received in the housing, and the housing is filled with the electrolyte 120 so that the parts are incorporated therein.

The monitoring electrode 300 according to the present invention is mounted in such a secondary battery 100, and has a first end portion 320 and the second end portion 340, in which the first end portion 320 is inserted into the inside of the secondary battery 100 so as to be incorporated in and surrounded by the electrolyte 120. As such, it is noted that the first end portion 320 of the monitoring electrode 300 is disposed so that it is prevented from coming into contact with both the cathode 140 and the anode 160 of the battery 100.

The second end portion 340 of the monitoring electrode 300 extends from the first end portion 320 and has branches 342, 344 respectively connected to the cathode 140 and the anode 160. In such a configuration, the monitoring electrode 300 has three nodes respectively connected to the electrolyte 120, the cathode 140 and the anode 160 of the battery. Such a monitoring electrode 300 is connected to a switching part 400 which will be described later so that the cathode 140 and the anode 160 are electrically connected or the cathode 140 and the first end portion 320 are connected or the anode 160 and the first end portion 320 are connected, thus measuring not only the difference in potential between both ends of the battery but also the voltage of just the cathode 140 or just the anode 160.

When the voltage of the cathode 140 or the voltage of the anode 160 is independently measured in this way, the voltage of the corresponding electrode may be utilized as data for evaluating safety of the electrodes, preventing the battery from deteriorating because of rapid charging, etc., there are a variety of actual uses thereof.

The first end portion 320 of the monitoring electrode may be coated with an insulating layer 322 so that it is insulated from the cathode 140 and the anode 160 in the electrolyte 120.

The insulating layer 322 is preferably made of the material that is required to be insulated from the cathode 140 and the anode 160 and to electrically communicate with the electrolyte 100. The first end portion 320 may be coated with either platinum, lithium, or lithium titanate.

FIG. 3 is a block diagram showing a secondary battery according to another embodiment of the present invention. As shown in FIG. 3, in the secondary battery 100 which includes a cathode 140, an anode 160 and an electrolyte 120, the monitoring electrode measures voltage of each of the cathode 140 and the anode 160 and includes a pair of first end portions 320 inserted into the secondary battery 100 so as to be incorporated in ad surrounded by the electrolyte 120, but positioned so that it is not in contact with the cathode 140 or the anode 160, and a pair of the second end portions 340 extending from the pair of first end portions 320 and connected to the cathode 140 and the anode 160.

In this case, the monitoring electrode 300 originally has a pair of lines. Hence, the voltage of both ends of the battery may be independently or simultaneously measured using the monitoring electrode 300 connected to the cathode 140 or the anode 160 without the need for an additional switching part 400.

Also, the secondary battery using such a monitoring electrode includes a housing having an inner space defined thereby. In this case, the cathode 140 and the anode 160 are received in the inner space of the housing and the electrolyte 120 is loaded into the inner space of the housing. The monitoring electrode 300 includes a first end portion 320 that is inserted into the inner space of the housing so as to be incorporated in and surrounded the electrolyte 120 but positioned so that it is not in contact with the cathode 140 or the anode 160 and the second end portion 340 of which extends from the first end portion 320 and has branches 342, 344 respectively connected to the cathode 140 and the anode 160.

Also, the secondary battery may further include a switching part 400 connected to the first end portion 320 and the branches 342, 344 of the second end portion of the monitoring electrode 300 so that the first end portion 320 and the cathode 140, the first end portion 320 and the anode 160, or the cathode 140 and the anode 160 are electrically connected.

In the illustrative embodiments of the present invention, depending on the selection of switching of the switching part 400 provided as shown in FIG. 2, in the case where both ends of the secondary battery are connected, the difference in potential between both ends thereof may be determined. Furthermore, in the case where the cathode 140 and the first end portion 320 are connected, the voltage of the cathode 140 may be measured, and also in the case where the anode 160 and the first end portion 320 are connected, the voltage of the anode 160 may be measured. Thereby, the voltage of the above three cases may be determined using only a single component. Moreover, in addition to measuring the voltage of each of both ends of the battery, the need for a conventional voltage meter is obviated, thereby reducing the manufacturing cost. The secondary battery according to the present invention may further include, however, a voltage measurement part connected to the switching part 400 to measure a difference in potential between the first end portion 320 and the cathode 140 or between the first end portion 320 and the anode 160. The voltage measurement part (not shown) is connected to the switching part 400 so that voltage is measured depending on the switching of the switching part 400, and data thus obtained is transferred to electric/electronic sub assemblies, etc., such as a BMS (battery controller), so that the deterioration degree of the battery may be determined, and the control of the battery becomes possible so as to ensure safety, and as well as provide a warning to a user before a dangerous situation occurs, thereby increasing the safety and marketability of vehicles.

As described hereinbefore, the present invention provides a monitoring electrode and a secondary battery using the same. The monitoring electrode according to the present invention enables the measurement of not only the difference in potential between the cathode and the anode of the secondary battery but also voltage of each of the cathode and the anode, thus prevents the performance of the battery from deteriorating and increases the safety and marketability. Also, problems with embodying the rapid charging techniques of batteries can be eliminated, so that more efficient battery charging techniques can be developed in the future.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An electrode for monitoring and measuring a voltage of each of a cathode and an anode of a secondary battery having the cathode, the anode and an electrolyte, the electrode comprising:
first end portion inserted into the secondary battery so as to be incorporated in the electrolyte but disposed so that the first end portion is not in contact with the cathode or the anode; and
a second end portion extending from the first end portion and having branches respectively connected to the cathode and the anode.

2. The monitoring electrode of claim 1, wherein the first end portion is coated with an insulating layer so that it is insulated from the cathode and the anode in the electrolyte.

3. The monitoring electrode of claim 1, wherein the first end portion is coated with any one selected from among platinum, lithium, and lithium titanate.

4. An electrode for monitoring and measuring voltage of each of a cathode and an anode of a secondary battery comprising the cathode, the anode and an electrolyte, comprising:
a pair of first end portions inserted into the secondary battery so as to be incorporated in the electrolyte but disposed so that the first end portion is not in contact with the cathode or the anode; and
a pair of the second end portions extending from the pair of first end portions and connected to the cathode and the anode.

5. A secondary battery, comprising:
a housing having an inner space defined thereby;
a cathode and an anode received in the inner space of the housing;
an electrolyte loaded in the inner space of the housing; and
a monitoring electrode including a first end portion inserted into the inner space of the housing so as to be incorporated in the electrolyte but disposed so that the first end portion is not in contact with the cathode or the anode, and a second end portion extending from the first end portion and having branches respectively connected to the cathode and the anode.

6. The secondary battery of claim 5, further comprising a switching part connected to the first end portion and the branches of the second end portion of the monitoring electrode so that the first end portion and the cathode, the first end portion and the anode, or the cathode and the anode are electrically connected.

7. The secondary battery of claim 6, further comprising a voltage measurement part connected to the switching part to measure a difference in potential between the first end portion and the cathode or the first end portion and the anode.

8. A method comprising:
monitoring and measuring, by an electrode, a voltage of each of a cathode and an anode of a secondary battery having the cathode, the anode and an electrolyte,
wherein a first end portion inserted into the secondary battery so as to be incorporated in the electrolyte but disposed so that the first end portion is not in contact with the cathode or the anode, and
wherein a second end portion extends from the first end portion and has branches respectively connected to the cathode and the anode.

9. A system comprising:
a battery;
an electrode configured to monitor and measure a voltage of each of a cathode and an anode of a battery having the cathode, the anode and an electrolyte,
wherein a first end portion is configured to be inserted into the secondary battery so as to be incorporated in and surrounded by the electrolyte but disposed so that the first end portion is not in contact with the cathode or the anode, and
wherein a second end portion extends from the first end portion and has branches respectively connected to the cathode and the anode.
